(19) United States
(12) Patent Application Publication
(10) Pub. No.: US 2008/0235038 A1
(43) Pub. Date: Sep. 25, 2008

(54) METHOD, SYSTEM AND COMPUTER PROGRAM FOR ENABLING LIVE SALES SUPPORT

(76) Inventor: Joseph Szamel, Budapest (HU)

Correspondence Address: MILLER THOMPSON, LLP, Scotia Plaza, 40 King Street West, Suite 5800, TORONTO, ON, M5H 3S1, CA

(21) Appl. No.: 11/688,328

(22) Filed: Mar. 20, 2007

(51) Int. Cl. G06Q 90/00

(52) U.S. Cl. 705/1

(57) ABSTRACT

A method, system and computer program is provided for enabling live sales support for a salesperson where the sales process depends on information or approvals from a remote office. The invention provides for the capture and digitization of written information obtained by a salesperson in consultation with a customer. Data is transferred to one or more remote computers defining back office systems, and processed according to pre-determined rules that support the particular sales process. Feedback is provided to the salesperson, including, for example, enabling conclusion of a sales transaction. The invention enables the mobilization of salespersons at relatively low cost while maintaining integration with office systems located at a remote office location. The invention also enables interaction with other system(s) or personnel assisting/providing approval to the sales transaction. The invention further enables the payment to conclude the sales transaction.

### FIELD OF THE PRESENT INVENTION

The present invention relates to methods and technologies for supporting and enabling sales transactions. The present invention more particularly relates to methods and technologies for providing live sales support information and transactional capabilities, such as immediate digitization of data, transfer of sales information, customer identification, data validation, credit checks, updating data files, initiation of payment transactions, etc.

### BACKGROUND OF THE PRESENT INVENTION

The importance of effective processes and supporting technologies for realizing sales is well known. In many areas, sales agents require a variety of tools to conduct a sales interaction effectively, especially in relation to products and services where closing the sale requires the sales agent to (1) conduct a needs analysis to establish the product or service that is most suited to the needs of the potential customer (and therefore most likely to be of interest to the potential customer), (2) answer numerous product or service related questions, and (3) obtain feedback from an external system(s), such feedback consisting of, for example, customer identification, data validation, or pricing information, such information being based on, for example, information regarding a particular potential customer or product/service considered, or obtain feedback such from a designated person, supervisor, or risk manager within the organization who provides, for example, approvals, price determinations, transaction authorizations in order to conclude the sale.

Often it is desirable to conduct sales meetings at the customer's location, whether their home or office. Sales are often improved if it is made more convenient for the customer to engage in the sales process, for example, by reducing travel time for the customer or fitting into the customer's schedule. These objectives are promoted by the in person meeting at the customer's site.

As referred to earlier, the typical sales process includes (1) a customer needs analysis, (2) capturing and processing sales information, and (3) one or more approval and/or fulfillment processes, whereby customer's requests are approved and/or fulfilled. The entire cycle might take as long as weeks, even months to complete. What is needed therefore is technology capability to reduce this cycle, whereby needs analysis, capturing, digitization and transfer of all sales related information deemed essential for the given sales transaction, information processing, approval and finally the fulfillment are possible within one session and in a short time with the customer.

In many situations, despite the advanced state of information technology, paper based systems are common for sales meetings at the customer's location. The paper based systems generally involve forms for managing the sales process (i.e. key information to be obtained from the customer, obtaining initials reflecting acceptance of key provisions and a signature evidencing acceptance of the sales terms/conditions and transaction as a whole). The paper based systems also often involve sales information such as fact sheets, brochures, specifications or demonstration/presentation materials, often organized in binders that enable the salesperson to show information and materials and to respond to questions of potential customers that arise in the sales process, including in some cases documentation that can be left with the potential customer for further consideration.

While the paper based systems are inexpensive from the point of view of technology investment and are easy to use for salespersons, one of their key disadvantages is that the results of the sales process (e.g., customer information or contract resulting from the sales transaction) requires subsequent digitization in order to capture these results in the various systems that are commonly used by companies to manage their valuable customer data and contracts. This additional step of subsequent digitization, as opposed to immediate digitization, as part of the sales process can be very costly and also error prone, particularly in the case of high volume sales transactions. Another disadvantage of the paper based systems is that the feedback from the office mentioned above is obtained most efficiently via electronic means that are not part of such systems by definition, and integrating electronic means in the paper based system, while desirable for obtaining prompt feedback, increases the cost and can be cumbersome as it would require sales agents to manage both paper and electronic resources. Accordingly, with the paper based systems there is usually further processing that is required at the office, whether this is digitization and processing of data recorded and submitted to the office, obtaining approvals, confirming pricing, or generating contracts for signature based on approval.

In part to address some of the aforesaid disadvantages of paper based systems, computer-based sales systems have been devised that usually include a laptop and software installed on the laptop that is operable to display sales information, assist in management of sales meetings, fill out electronic forms, and possibly even generate contracts. These sales systems are generally custom built for a particular organization. These computer-based sales systems can be categorized into systems that are designed to function off-line, and systems that function on-line (although some exist that are hybrid and function in both off-line and on-line modes). By off-line what is meant is that the system operates without an Internet or other type of connection to other computer system(s) during the actual sales session. On-line systems require some type of Internet or other type of connectivity during the sales session.

Computer-based sales systems that operate in off-line mode simply gather sales information that is subsequently uploaded to the office for further processing. Sales forms are made available on the computer device (usually a laptop) in digital form. In addition, the system generally includes a repository of sales information in electronic form. The salesperson can fill out the sales forms electronically, and then subsequently the salesperson connects to an office network (e.g., via a docking station, Internet Portal, etc.) whereby sales data, including completed sales forms, are uploaded to the network and then processed. Once a sale is approved, the necessary documents are generated and are sent to the customer. Once connected to the network, software, sales information and sales forms resident on the laptop are updated if necessary.

These systems provide the advantage of real-time data digitization with or without the capability of some degree of data editing and validation. They might also provide information useful for the salesperson during the given sales transaction, such as available components, riders, accessories, possible add-ons, etc.

With the off-line laptop based solution there is the problem of the delay of required feedback from other personnel or systems thereby resulting in lengthening of the sales cycle. There is the additional disadvantage of the relatively significant costs of acquisition (hardware and software), replacement and upgrading, as well as maintenance costs associated with the various (mainly software) system components overall. In addition, many sales agents are familiar with particular paper forms, and the computer-based solutions generally involve the use of processes and interfaces embodied in the software program that the sales agent is not familiar with or comfortable with, resulting in training costs and barriers to adoption. Some customers that are used to paper based forms may show a lesser degree of acceptance of the computer-based sales process. Moreover, especially in situations where a signature is required or desirable, this generally cannot (without additional hardware and software, or the requirement for the customer to sign up under a digital signature scheme, such as a Public Key Infrastructure system) be collected in connection with the computer-based sales system. In many cases, this results in the need for a further visit by the sales agent, which involves the customer signing the requisite forms, in order to maintain the in person nature of the sales cycle. In other words, it is sometimes not desirable to simply deliver the forms to the customer for signature without an in person meeting. Scheduling and conducting these follow up visits can be time consuming and inconvenient for both the customer and the sales organization.

In addition, computer based sales systems are known where the computer (also usually a laptop) is configured to create a live communication link with office systems during the sales process for interactive communication. Ensuring that an Internet connection will exist for every meeting is quite difficult. Trying to verify that the customer's site has an Internet connection is itself time consuming, and in the end having to struggle to resolve these issues can result in inefficient sales meetings and a negative impression by the customer regarding the sales agent and organization when connectivity issues are not resolved very quickly. Also, the purpose of the in person meeting is often to save time of the customer, and the frequent resolution issues involved around Internet connectivity can obviously have the opposite effect. The increasing availability of wireless data networks is diminishing this problem, but these are not available everywhere, and there are gaps in such networks in any case. However, if a sales meeting takes place at the customer's office, there are obvious security issues involved in connecting various computer devices (such as laptops) to corporate networks, and consequently many organizations have developed policies against this. There is also the issue of the fairly significant costs in connecting to such networks, not to mention the acquisition, training and other costs associated with computer-based sales systems generally, as outlined in connection with the off-line computer-based systems above. In addition, the hardware, software and processes involved in ensuring that every on-line capable laptop has the same updates to software, forms, sales information, etc., are relatively costly. Furthermore, the fact that salespersons in the field are regularly accessing the office network in sales transactions generally requires that the office network be configured in a manner that exposes the network, at least to a degree, to security risk, and therefore requiring additional investment in reducing this risk.

Call centers including managed computer networks, and trained sales staff on personal computer connected to such computer networks engaging in sales transactions with customers via a communication medium are well known. These call centres, and the various supporting technologies, were devised in part to address the challenges of facilitating the in-person like sales experience, as outlined above, especially in situations where the feedback described is a prerequisite. Call centers are also meant to be staffed by highly trained professionals with access to sophisticated technologies enabling them to provide customer support equal or superior to that provided by a typical sales force. Additionally, call centres, in the presence of economies of scale, are generally more cost effective than the computer-based solutions described above and have the added advantage of permitting the close management of the performance of the sales agents working in such environments.

However, the call centres utilize complex technologies, and they are costly to set up and maintain. Call centers are also ‘faceless’, i.e. there is a lack the face-to-face personal touch. Because sales transactions that they facilitate are not in person, there is a loss of the intimacy and the eye to eye contact that generally improves the effectiveness of the sales process. Customers often find interacting with call centres impersonal and that communication with sales agents over the phone can be sometimes quite difficult. The public generally resists interaction with voice applications (which often require pushing multiple buttons and listening to multiple recorded messages), often represented by the incoming phone traffic processing technologies (interactive voice response) or the intrusiveness of outgoing sales campaigns. Furthermore, in many situations there is the added requirement of sending documents for approval and/or signature and getting these documents back in order to close the sales transaction, which can result in certain sales not being closed that would have been closed in person. The follow-up processes that are required to obtain approval and/or signing the documents/contracts in order to complete the sale are often lengthy and expensive.

Various technologies are known that enable simultaneous completion of sales forms using a traditional writing and facilitate the simultaneous digital capture of the completed form data.

For example, “digital paper” technology is marketed under the brand ANOTO™. The ANOTO™ base technology is described in U.S. Pat. No. 5,852,434. The ANOTO™ technology includes a paper surface that is overlaid with a digital pattern consisting of a pattern of small dots printed on the paper surface in a manner that the pattern is unique within the paper surface within localized areas. In combination with a digital (ink) pen, when a user marks the paper surface, the built-in digital camera of the digital pen captures images of the marks in combination with the digital pattern, thereby enabling the marks to be associated with specific locations on the paper surface. Using character/handwriting recognition software, images of marks are turned into digitized information and processable data.

There is a need for a sales system that integrates paper based forms while enabling simultaneous digitization in a sales support solution for in person sales meetings that is operable to obtain feedback from the office related to the sales process. There is a need for such a solution that is cost effective and has improved connectivity and availability characteristics.

### SUMMARY OF THE PRESENT INVENTION

The present invention is a method, system and computer program for providing live sales support. The method, system and computer program is best understood as a means for enabling live sales support for a salesperson where the sales process depends on information or approvals from a remote office/computer system.

In one aspect, the present invention is a method for enabling sales support to a salesperson remotely located from an office, the method comprising: receiving data from the salesperson, wherein the data is generated using a digital pen and sent using a communication device; processing the data; and generating feedback to the salesperson. The feedback can include specific information, one or more approvals, one or more requests for further information, or can enable the conclusion of a transaction.

In one embodiment of the present invention, the data is generated using the digital pen in conjunction with a digital sales form during a consultation meeting between the salesperson and a customer. The digital sales form and the communication device (including the specific programming loaded on the communication device, or functions implemented on the communication device by operation of interactions between the communication device and a remote server) enable: (i) digital capture of data from the digital sales form; and (ii) forwarding of captured data to the office.

One representative embodiment of the present invention includes a digital pen having a built-in pressure sensor, which activates a digital camera that records pen strokes, specifically by recording the position of the pen on a paper based form; the paper based form consists of “digital paper”, which includes tiny, nearly invisible dots on the surface of the paper. The digital paper and digital pen co-operate to enable the digital pen to recognize its location on the form. The digital pen preferably includes a transceiver, such that the captured pen strokes can be sent, for example to a BLUETOOTH™-equipped mobile communication device nearby.

In another aspect of the present invention, a method of enabling sales support comprises defining a particular sales form according to a particular sales process, and defining a processing template based on the sales form. The processing template is stored on a remote server and used to process the data received from the salesperson.

The system of the present invention, in one aspect, comprises a digital pen used in conjunction with a sales form, and a communication device operable to transmit data from the digital pen to a server. For example, the communication device can be a mobile phone, a tablet or laptop computer, or a mobile phone linked with a tablet or laptop computer. Accordingly, the communication device and the server are interoperable to compare data as against one or more processing templates implemented on, or linked to, the server. Depending on the input data, one or more required approvals might be automatic, or one or more approvals may be required from specific office personnel, for example.

In another aspect of the system of the present invention, an Application Program Interface (“API”) is provided that links to back office systems, the back office systems hosting various applications related to the particular sales process. The API provides an interface between the communication device and the back office systems. The API may also be linked to a database, the database including a rules repository with one or more processing templates.

According to one embodiment of the present invention, the system is therefore operable to: (i) define a digital sales form for a particular sales process; (ii) define a processing template based on the digital sales form and store the processing template to a database; (iii) digitally capture information data obtained in a sales process; and (iv) send and receive the digitally captured information data via a communication device to one or more remote computers in conjunction with one or more processes that support the sales process, e.g., approvals, risk analysis, live confirmation of availability of resources or goods associated with the subject matter of the sales process; and (v) obtain necessary feedback, if applicable. The system is further operable to: (vi) obtain the results of the processes that support the sales process; and (vii) thereby enable conclusion of the sale.

The computer program of the present invention, in one aspect thereof, is best understood as a computer application or computer applications that when loaded on a computer(s) is(are) operable to facilitate the system described above.

The present invention advantageously enables live support so that salespersons can remotely carry out functions that are essential to many sales transactions, such as credit checks, setting up direct debit transactions, real time payments, etc., with relatively little processing and communication infrastructure. The present invention can be specifically applied for the provision of live sales support in the context of insurance sales, mortgage applications, sales of consumer goods, and credit card/personal loan applications, as examples.

### BRIEF DESCRIPTION OF THE DRAWINGS

A detailed description of the preferred embodiments is provided herein below by way of example only and with reference to the following drawings, in which:

FIG. 1 is a schematic diagram illustrating components of a system in accordance with the present invention.

FIG. 2A, FIG. 2B and FIG. 2C illustrate a digital pen connected with a communication device in three different embodiments thereof.

FIG. 3 is a schematic diagram illustrating back end systems in greater detail.

FIG. 4 is a flow chart illustrating method steps in accordance with the present invention.

FIG. 5 illustrates an example form for a particular application of the present invention, namely a vessel insurance application.

FIG. 6 illustrates an example form for a particular application of the present invention, namely a mortgage application.

FIG. 7 illustrates an example form for a particular application of the present invention, namely tool sales.

FIG. 8 illustrates an example form for a particular application of the present invention, namely a credit card/personal loan application.

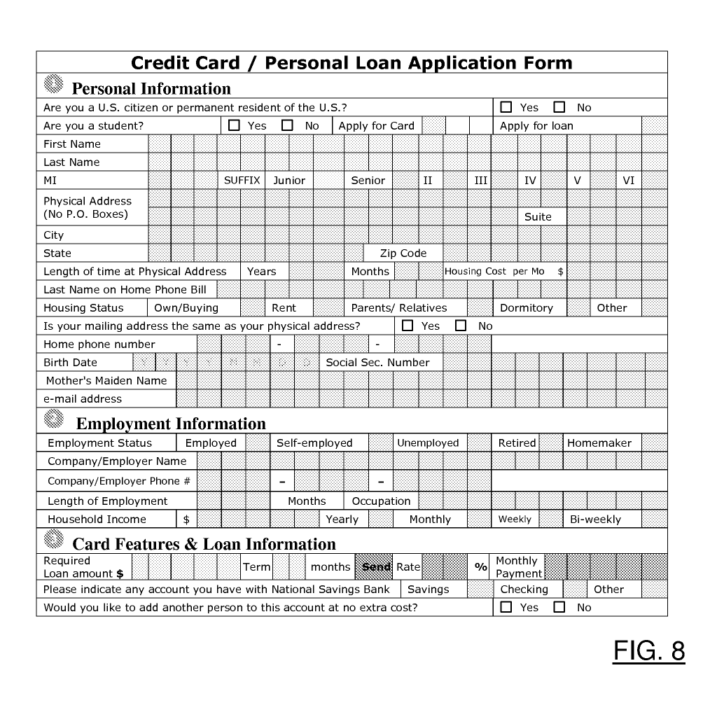

In the drawings, one embodiment of the present invention is illustrated by way of example. It is to be expressly understood that the description and drawings are only for the purpose of illustration and as an aid to understanding, and are not intended as a definition of the scope, areas of application, and/or limits of the present invention.

### DETAILED DESCRIPTION OF THE PRESENT INVENTION

The system of the present invention is best understood as a sales support system where the sales process depends on one or more business conditions, such as on approvals from one or other members of personnel of a business and/or another system. The system captures information deemed essential to: (i) determine the best possible match between needs and available products/services; and/or (ii) complete the actual sales process.

In one embodiment, information is written with a digital pen on a form pre-printed on digital paper, i.e. a medium with digital pattern on it. This enables the information to be instantly digitized with relatively little communication and processing infrastructure. The information can also be encrypted. Any standard (or proprietary) encryption product/technology can be used, depending on the end-user requirement at hand.

“Digital pen” in this disclosure generally refers to a prior art digital ink pen which incorporates a conventional ink pen as well as a digital pen such that a user can write on a paper form and the writing is simultaneously captured digitally by operation of the digital pen. Examples of such pens are those marketed by MAXELL™, LOGITECH™ (for example the IO2™ pen) or the SU-1B BLUETOOTH™ Digital Pen of NOKIA™.

It should be understood that while this invention refers to “digital paper” in a number of locations, it is not essential that the forms of the present invention be provided using a particular digital paper technology. In addition to the ANOTO™ type technology discussed above, means can be provided, for example, that enable a user to select a particular digital form that corresponds to a paper form, and then to establish a starting point on the paper form, which is then correlated to the digital form whereby subsequent entries on the paper form are associated with the corresponding fields on the digital form.

One aspect of the present invention is the end to end process of a sales transaction that is made possible using the system of the present invention. The actual form is provided by or tailored for the particular company wanting to use the system. As part of the present invention, the form reflecting the specifics of actual product of the company to be sold is overlaid with a unique digital pattern.

The present invention makes salespersons technology-enabled thereby allowing the completion of functions that are essential to many sales transactions, such as data capture, data validation, customer rating, establishing discount factors, credit checks, approvals, setting up direct debit transactions, possible execution of real time payments, etc., with relatively little processing and communication infrastructure. In the absence of such technology-enablement, many sales transactions end up in time consuming and expensive follow-up processing and/or subsequent sales approval/authorization. The present invention allows companies to deliver their products and services to the ‘door step’ of their customers and complete the entire cycle of sales on-the-spot, inclusive of digitized data capture, data validation credit checks and payment processing, capturing of customer's signature, etc.

Use of the present invention creates the ability to digitize all relevant information at the point of inception (i.e. point of sale) and its transfer to an office for further processing. The nature of processing and the systems used for same vary from company to company. Insurance companies, for instance, typically have well-defined processes and have different systems to help to analyze and approve risks. The underwriting process often includes staff with specialized expertise as well.

The fact that, with the present invention, all information generally required to conduct the needs analysis or the sales process exists on paper in written format means that the system of the present invention can also serve as back-up solution in case there is a network failure disabling communication between the salesperson and the office or any other system break-down.

It should be understood that one of the advantages of the present invention is that it enables the mobilization of salespersons at a relatively low cost, while maintaining integration with office systems at a remote location. In a business where traditionally customers attend at the location of the seller, the present invention is particularly suited to generating sales in relation to individuals who for a number of reasons cannot integrate the sales process requiring travel to another location into their schedules.

One example of such a person is a busy professional, especially if s/he works relatively far from the seller's location and/or there is significant traffic congestion in the relevant area. Another example is a person providing care to children for whom it could be quite inconvenient to find alternate childcare to engage in a sales transaction. With these individuals the present technology offers an easy and inexpensive way to mobilize a sales force using forms that the salesperson may already be familiar with and while maintaining electronic connection with any back office (system) linked to the sales process.

One example that illustrates the advantages of the present invention is the purchase of an automobile. Dealerships are often located relatively far away from where people work. The purchase of an automobile for certain individuals is often delayed because the sales transaction does not fit in with the schedule of the potential buyer. The present invention in this case enables customer service to be customized in such cases by having a sales agent attend the workplace of a customer. With the digital forms, as described, and sales literature in hand, the salesperson can conduct the entire transaction involving for example approval for financing and determining delivery date of a particular model with specific features selected by the customer in essentially real time at the location that suits the customer, and with relatively low infrastructure costs and training cost to the dealership. The present invention enables, for example, a salesperson in a car dealership to schedule visits to regular customers with demanding jobs during down times at the sales location.

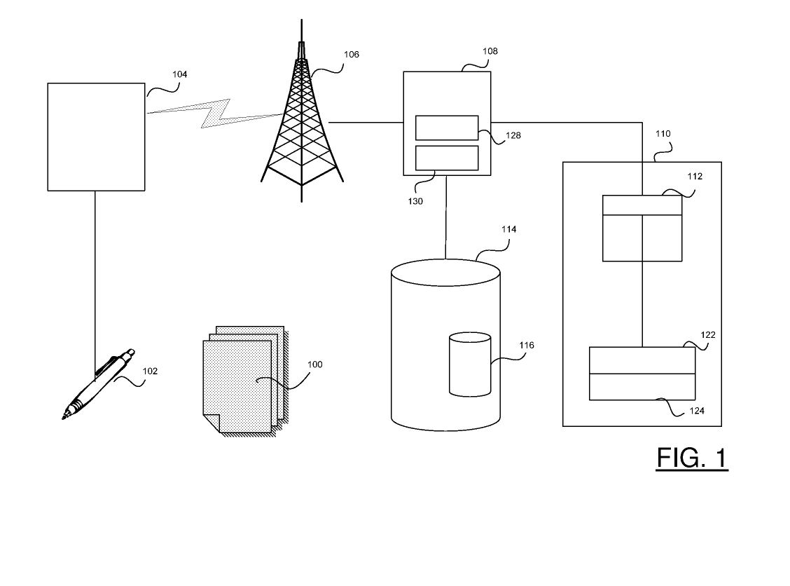

As best illustrated in FIG. 1, it should be understood that the system of the present invention relies on and is based on three main technology components: (i) a digital sales form (100); (ii) a digital pen (102); and (iii) and a communication device (104).

In this disclosure a “digital sales form” refers to a paper form that relates to a sales process and enables the digital capture of data in a structured format that relates to the digital sales form. More particularly, the “digital sales form” refers to a paper form that enables simultaneous digitization, or is linked to a means for providing such digitization. Still more particularly, the “digital sales form” refers to a form that embodies the steps of a sales process, including obtaining feedback related to the sales process from a remote office in essentially real time.

The system of the present invention is therefore operable to: (i) capture and digitize written information obtained during the sales process; and (ii) transfer the data captured digitally and optionally encrypted to one or more remote computers defining back office systems (110) according to pre-defined rules that support the sales process, e.g., approvals, risk analysis, real time confirmation of availability of resources or goods associated with the subject matter of the sales process.

The system is further operable to obtain the results of the interaction(s) with other processing systems, database(s) and/or possibly with expert staff that support the sales process, by, for example, providing approval, and thereby provide specific feedback and/or enabling conclusion of a sale with a live commitment from both the service/product provider and also of the customer. The customer's signature can be obtained on the digital sales form and also captured digitally on the digital paper with biometric accuracy, if necessary. A technology for capturing digital signatures and “sealing” the document for authentication purposes such as that marketed by TRODAT™ can be used.

In a particular embodiment of the present invention where digital paper is used to provide the digital sales forms (100), the forms are made unique as a batch or each page individually is unique, and therefore, for example, an insurance application form provided in this manner can also serve as an insurance policy form, once the office underwrites the risk and authorizes the real time issuance of the policy number. In a particular aspect of the implementation of the present invention, a unique ID associated with an insurance application form, for example, can also be used as a sales authorization number and/or policy number.

In another aspect of the present invention, there is a design phase that relates to designing the particular digital sales form (100). A company supplies the paper based form(s) to be utilized during a sales process along with the rules for processing the information captured on the form. In most cases, such forms used by companies are designed to contain all information necessary to complete the sale of a particular product. The design/structure of the form is reviewed ensuring that it conforms to the live sales process based on the possibilities of interactive communication facilitated by the present invention with the salesperson in the field. It is important that all information relevant for making proper decision(s) is captured and transmitted for processing. Knowing what information is required by the systems at the remote office in order to support the sales at hand is an important consideration. Once that information (i.e. the content of the form) is known, the layout/sequence of the data fields is established in conformity with the sales/approval process.

It should be understood that the digital sales form (100) can be “optimized” in the sense that the sales process and form that embodies the sales process in the sequence of questions and answers that are obtained in completing the form, can be structured in a way that feedback is obtained in essentially real time, in a manner that does not disrupt the overall sales process. For example, aspects of the digital sales form (100) that require confirmation or approval can be placed in the sales process and the digital sales form (100) in a way that the time required in order to obtain the feedback is spent by providing information, answering questions to, or obtaining information from the customer. In other words, interruption of the sales process by the feedback processes is reduced or eliminated all together.

Subsequent to the finalization of the layout, the sales form is “overlaid” with a digital pattern as described and allocated to the particular digital sales form in order to enable the real time digitization of data to be written on it. The digital pattern can be unique per page or per batch of forms depending on the given business requirements of the company.

Each digital pen (102) has a unique ID enabling the company to identify the salesperson as per each data transmission. This particular feature enables the company not only to maintain an accurate audit trail but also allows important sales information to be derived regarding the information and relationship management with customers.

The digital pen (102) can be linked to a character recognition program, whether associated with the communication device or a computer in addition to the communication device. Examples of suitable character recognition program such as MYSCRIPT™ from VISIONOBJECTS™.

Information written on the digital sales form (100) with the digital pen (102) is digitized, optionally encrypted and stored, and thereby is ready for transmission via the communication device (104). For example, the data is stored on the digital pen (102) itself. Different makes of digital pens (102) have different data storage capacity. The current newer generation of pens can hold a total of about 200 forms. There can be different types of connections to the communication device (104), for example: (i) BLUETOOTH™; or (ii) universal serial bus (USB).

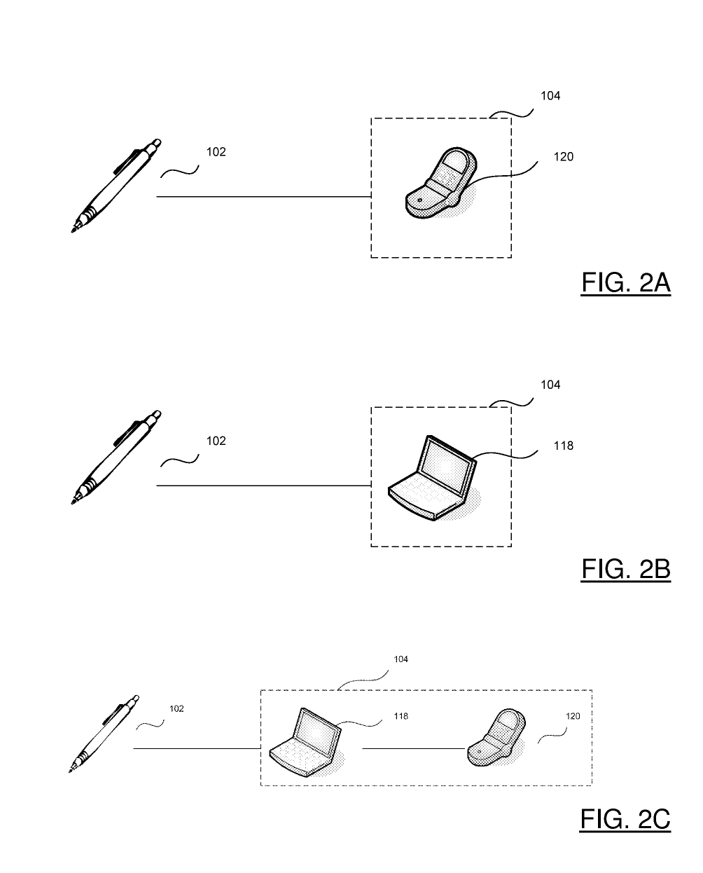

It should be understood that “communication device” in this disclosure means any type of electronic device that is capable of supporting (two way) data transmission via wireless Internet, GSM, CDMA telephony or any other type of communication technology, as well as a connection to the digital pen (e.g. BLUETOOTH™ enabled or USB connection) such as a BLUETOOTH™ or USB equipped cellular telephone, PDA, notebook, laptop, PC, etc. The communication device (104) is generally connected to a cellular network (106). This type of network is more generally available and provides greater operational stability than Internet networks available to the prior art on-line lap top based solutions. Furthermore, the communication device (104) consisting of a wireless communication device such as a mobile phone or PDA is generally less costly and more portable and robust than a laptop, as shown in FIG. 2A.

It should be understood that the communication device (104) may nonetheless consist of a portable laptop (118) that is connected to the digital pen (102) for processing the digital (paper) forms (104) of the present invention, as illustrated in FIG. 2B. The laptop (118) may be used particularly in areas where, for example, its functionality is desired to display information in electronic form to a customer. It is possible that the communication device (104) will consist of a mobile phone (120) and in addition a laptop for such purposes, as illustrated in FIG. 2C. In some cases, the mobile phone (120) and the digital sales form in combination may provide a backup where Internet connectivity cannot be readily provided to the laptop (118).

The digital sales form (100) generally includes at least one “SEND” box located on the form marking the end of a logical section. Marking the “SEND” box triggers the execution of a generic (e.g., provided as part of the ANOTO™ functionality) or a proprietary program. The “SEND” box consists of an area that is defined on the digital sales form (100) which when marked using the digital pen (102) initiates on the communication device (104) a process whereby some or all digitized information is communicated to the remote office, in association with a particular process. This process can be coded in the communication using an identification tag that, for example, identifies a specific rule or process. In line with the concept of a thin client solution, the communication device can perform functions such as data encryption/decryption, some degree of data editing/validation, providing time stamps to data strings transmitted, etc., in order to reduce communication costs and increase speed of processing.

A routing means such as routing software loaded on the communication device (104) enables transmission of data to a predefined server address or predefined multiple server addresses for further processing in a manner that is known.

It should be understood that the remote office will generally include one or more back office systems (110) that may include an application repository (124) for hosting various applications involved in processing, recording, and analyzing transactions. This is certainly the case with typical banking and insurance environments as an example. In one aspect of the present invention, the digital sales form (100) and communication device (104) are integrated with the functions of the back office system (110), and the various processes that are embodied in the back office systems (110) including the application repository (124), access to which is provided via the server (112) through the server application (122). This is achieved by ensuring that the digital sales form (100) is consistent with back office processes, and also that incoming data from the digital sales form completion process is tagged and/or translated to a form that enables relevant data elements to be included in the workflow of the back office systems (100) on a seamless basis.

To this end, in one particular aspect of the present invention, the system includes a customizable Application Program Interface (“API”) (108) which provides an interface between the various communication devices (104) and the back office systems (110). The API (108) is operable to decrypt data received from the communication devices (104) (if the data is encrypted), tag the data as required in accordance with the back office system processes, translate the data into one or more formats if required by the back office system processes, interface with the application repository (124) that is part of the back office systems (110), and place data elements into the back office system workflow. The API is normally linked to a database (114) including a rules repository (116) that determines the specific rules for processing specific data (based on a field from a particular form, or particular data provided by a customer that escalates risk analysis, initiates credit checks, payment transactions, etc.), in accordance with predetermined back office processes.

The API (108) can also be understood as a data interchange.

In a particular aspect of the present invention, the API (108) includes a generic set of API's to retrieve the data and use them in various silos of applications (124) in back office systems (110).

In accordance with another particular aspect of the present invention, the back office systems (110) include a server (112), whether hosted by the sales organization or an outsourced entity, which will host the data from which data extraction takes place. The API preferably includes a data extraction module (128), for example, one based on the Electronic Data Interchange Service (“EDI”). The data extraction module (128) provides a mechanism for sending files to and/or retrieving files as part of the solution. EDI allows the transfer of structured and coded data, by agreed message standards, from computer to computer, by electronic means.

The API is linked to a database (114) that maintains the various types of form templates. Using this information, the data extraction module (128) can extract the relevant data from the pen data file(s) transmitted.

The data extraction module (124) is operable to generate files that can be used by the back office systems (110) for application integration purposes, by enabling file generation in accordance with specific file formats required by the back office system (110) or specific applications that are part of that environment. For example, the data extraction module (128) is operable to generate XML files based on data collected as part of the digital sales form (100). The solution will provide functionality for generating a file (e.g., XML) by default. Since the file generation is modularized, more sub-modules can be added to generate files in various formats for specific cases.

The data extraction module (124) is operable to create a structured file that corresponds to the electronic information embodied in the digital sales form.

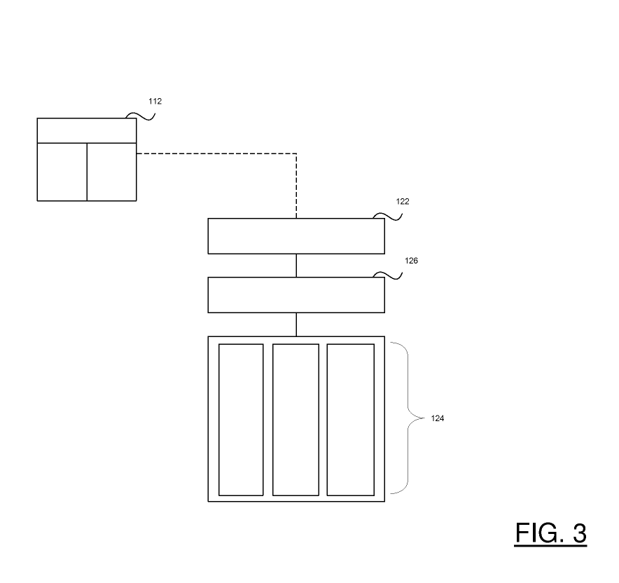

In one particular aspect of the present invention, as illustrated in FIG. 3, the back office systems (110) may include a listener/sender program (126) that is operable to monitor pre-defined ports in order to integrate data from the API (108) into the workflow of the back office systems (110). As soon as a file is generated by operation of the API (108), the listener/sender program (126) can read the file as a stream and process the data using its existing applications. Minor modifications may be required at the application level to receive the data in the file from the API instead of the manually entered data. The response after the data processing is completed can be sent back to the same port as another file. A messaging utility (128) linked to the API (108) as shown in FIG. 1 (but that may instead be linked to the back office systems (110), depending on the particular implementation) is operable to send information back to the communication device (104) in accordance with the sales process. The message could include the feedback described above, and could be provided in the form of a text message to the mobile phone (120) of the communication device (104).

It should be understood that, in accordance with specific implementations of the present invention, translation of the data is handled by the back office systems (110) rather than the API (108), i.e. the API of the present invention acts more as a standard API. The API (108) is operable to act as a hosting server for a plurality of customer scenarios. For example, the API (108) is operable to authenticate, validate and analyze data in accordance with a series of processing templates provided to the rules repository (116) prior to presenting the data to the back office systems (110), in accordance with specific implementations of the present invention. In particular, the processing templates are based on the digital sales form (100) and are stored in the rules repository (116) of the database (114) linked to the API (108), which in turn is linked to the back office systems (110).

It should be understood that the present invention also contemplates various tools to parse data and feed the data to applications linked to the back office systems (110), resolve errors, etc., whether as part of the API or part of the back office systems (110) themselves.

In sum, as illustrated in FIG. 3, the steps according to the method of the present invention include:
defining the digital sales form (100) for the sales process (200);
defining a processing template based on the digital sales form (100) and storing the processing template to a database (116) linked to the API (108), which API (108) is linked to the back office systems (110) (202);
processing the digital sales form (100) in connection with an in person sales meeting, including sending and receiving data via the communication device (104), and obtaining any necessary feedback (204);
processing data included in the digital sales form (100) by operation of the back office systems (110) (206); and
concluding the sales transaction, and reflecting the sales transaction in the back office systems (110) (208).

It should be understood that the present invention enables a company's sales agents to continue to use forms that they are familiar with, yet as part of a system where data is digitized, and therefore valuable information and feedback can be interactively obtained by operation of the back office systems (110) during the sales session. The digital sales form (100) described, integrated with the API (108) and the back office systems (110), enables a fully integrated digital sales process whereby the sales agent can engage in an in person sales meeting, almost as though the sales agent were in the office. This integration of the sales process is provided in a way that depends on more reliable network connectivity. The use of the paper based form enables collection of signatures for authentication and non-repudiation. The digital sales form upon approval can be turned into the actual sales contract that is left with the customer, as the relevant data required by the company from the digital sales form would have already been captured. This eliminates the steps and associated costs of sending the sales contract through other means. All of these advantages are provided in a cost effective manner, given that the acquisition costs for the technology components described are relatively small. The sales cycle, which can be divided into a number of distinct process components, such as needs analysis, description of product/service required, sales data capture, processing of sales data, transaction approval, fulfillment, shipment, etc., and can spread over a period of weeks (or even longer), under optimal circumstances, can be reduced to a single session. Reducing the time to close a sales transaction is typically a very high priority consideration. Many sales transactions fail to materialize due to lengthy execution.

An additional advantage of the present invention is the maintenance of a complete paper audit trail, which not only solves important issues such as capturing the customer's signature, it also serves as a fully functional backup solution to failures of a technical nature. Significant benefits can be realized by the use of the present invention by digitizing and transmitting the data captured on the digital sales form to the office and perform real-time data validation, since errors related to a form's completion are most efficiently corrected at inception rather than via lengthy follow-up procedures that might even require another sales meeting since the customer might have to acknowledge and approve the changes made to the form s/he signed previously. Depending on infrastructural conditions, the present invention creates the opportunity to initiate payment transactions allowing immediate revenue collection, which provides a major benefit to the sales organization.

The present invention is applicable in numerous areas. Its application is explained by considering three fundamental sales scenarios, each triggering a different set of considerations and administrative processes, each thereby presenting specific applications of the present invention:
1. Basic Sales. In this case, the product/service can be sold practically to anyone according to proper payment terms. The main system processing considerations in this scenario are product/service availability, price and distribution. Examples of this scenario are most retail businesses that operate physical or virtual stores selling consumer goods. Such products are generally made available to anyone willing to accept the payment and distribution terms.
   The use of the present invention enables the ‘traveling sales man’ to capture and transmit customer information to head office that is necessary to perform credit checks and also process essentially real time payment transactions. Since the present invention enables two-way communication between a salesperson and a head office, information, e.g., product availability, delivery schedule and details (such as airway bill number, tracking number, etc.), discount factor, price etc., can be made available to the customer on the spot. Depending on the particular retail business, one of the advantages of the present invention is a relatively inexpensive infrastructure for connecting sales staff to an office, for instance, for dynamic updating of discount offers made available to customers, for example, in order to clear inventory of specific products, or as a timely response to price point changes introduced by competitors.
2. Product Centric Sales. For this scenario, there are important mainly product-related considerations, such as component/version compatibility with previous purchase(s), payment history, product availability, etc., that govern the sales process. In order to properly address licensing, spare part reordering, availability and other issues, for example, the particular product consumption history of the client is important.
   The consumer software business is a good example of this. In this case, the true identity of the customer is not really relevant but what was previously purchased is essential to know in order to clarify component compatibility and licensing issues, for instance.
   Warranty repairs and bug fixes in integrated software and hardware environments generally can only be made available based on precise familiarity with previous purchases, what other related technology components are operating in the same integrated environment and their full, related maintenance history, for example. Many companies in this business use serial numbers, authorization numbers, version numbers, etc., to manage/control these processes.
   Another example of the Product Sales Centric scenario is where there is customization of a product, for example, in selecting the various optional features of a motor vehicle. As stated earlier, the selection of features, determining their compatibility with each other and availability of specific inventory, establishing delivery time based on selected features, enables integration of the sales process with the supply chain management process without the need of costly follow up.
   The use of the present invention allows information written on a form to be immediately digitized and transferred to a head office for processing, and essential information regarding the ongoing sales can be subsequently relayed back to the salesperson while in session with the customer.
3. Customer/Relationship Centric Sales. This scenario generally requires the most complex processing. In this case, the needs and consumption capabilities of a customer are brought in line with business and product strategy of the company. Often decisions regarding many aspects of the sales are made with the involvement of and interaction with different internal and external database and processing/expert systems (such as customer, product, accounting, payment history database(s), etc.) and/or expert staff.
   Banks and insurance companies typically use relationship centric methods in their customer relationship management approach. They often construct an entire life cycle based product/service model per customer that is based on individual analysis of customer “needs and wants”. Precise determination of the identity of the customer at the outset is critical in this scenario. The use of the present invention allows customer information written on the digital form to be digitized and transferred to processing systems of an office. The transmission of data includes a pen ID that identifies the salesperson, the ID of the form in use (for the product to be sold) and it also should include all data necessary to determine the identity of the customer, which then should enable the company to pull together all information required to best complete the sale at hand.
   Insurance companies for instance will recommend savings products for their customers with young children that will mature when the child reaches the relevant age for college/university education, at which time the sum assured will be paid to the child as tuition (subsidy). Since premiums paid for such products are often tax deductible, the requirement for thorough needs analysis, tax and financial planning is obvious. During such process, specific data must be captured and factored into the analysis so as to construct the product best suited for the given customer. The design of the form in terms of information content is critical in order to meet that objective.
   Thorough analysis and/or redesign of sales forms is therefore generally involved in order to adapt the traditional sales forms to the sales process facilitated by the present invention that is based on interactive two-way communication between a salesperson and a head office, allowing essentially real time execution of sales.
   Another similar example would be the sale of car loans or mortgage products by banks and insurance companies for customers who just completed their higher education and gained employment. Such sales leads/recommendations are often the result of customer-centric sales approach supported by different data-mining/customer relationship management systems. Individualized financial planning based on the intimate familiarity of customer needs therefore becomes very important in such businesses. Knowing what product fits best at a particular moment/stage in the life cycle for a particular customer often makes the difference between the successful or failed sales attempts. Providing salespersons with such knowledge is critical, which is why the present invention is based on the concept of two-way communication between the processing or ‘expert’ systems of an office and the salesperson in the field. For example, in the vessel insurance example discussed below, the premium payable by the customer might possibly be reduced if the insurance company directly or indirectly also holds the outstanding loan on the vessel. With the system of the present invention, such important information can be relayed back to the communication device of the salesperson who could then efficiently custom-fit the sales proposition by suggesting the refinancing of such loan.

Considering the above, therefore the typical sales process starts with the needs analysis that serves the purpose of making a precise determination of what the customer's needs are and how to best satisfy them.

Both the needs analysis and the subsequent sales process take place preferably utilizing digital paper based forms with a unique pattern provided as part of the present invention to be filled out using a digital pen. The design of the sales form is to be provided by the company wanting to use the present invention. The content (i.e. the information to be captured) and the layout of the form (the proper sequence of the information fields to be captured) are preferably precisely synchronized to reflect the sales process at hand. Price quotation, for instance, cannot be provided to the customer before all information impacting pricing is captured, digitized, transferred to and processed by head office. The design of the form preferably conforms to the requirements of a particular sales process, and is typically structured as follows:
Personal information is captured generally in the first section of the form, allowing the company to easily identify the customer. Such information is everything necessary for personal identification, i.e.: name and address, social insurance/security number, driver's license number, product number(s) from previous purchases, customer numbers, etc.
Along with the personal information captured on the form, pen and form identification indicating the product the customer is interested in are also transmitted, allowing the company's systems to gather information that might be relevant for the sales effort at hand. As part of the sales support provided to the sales agent, this information can be displayed at the communication device. This information might include, for example, information regarding the purchase patterns of the customer in the past, demographic details (number of children, their age, etc.), which assists the sales agent in inferring what products/services might be of interest to the customer.
A product information section serves the purpose of collecting information regarding the specific features of the product, i.e. the insurance coverage in the current example that the customer is interested in.

Once this block of information is sent and processed, the company knows exactly who the customer is and what his/her current interest is, enabling the company to process approvals that may be related to the sales process, as part of the sales support provided to the sales agent. Normally, the sales agent would only be able to take the sales process to a certain point after which s/he would have to follow up with relevant personnel to obtain necessary feedback/approval. This requires extra work from the sales agent, and delay that can sometimes result in the customer changing their mind and deciding not to proceed with the transaction. In any case, the ability to obtain necessary feedback within the time period of the sales call generally solidifies the sales opportunity and results in positive customer perception of the seller in terms of the efficacy of the service provided. Necessary feedback may relate to approvals associated with determining whether or not a particular product or service is available to the particular customer, or credit approvals. The feedback may also include confirmation of products/components/parts, raw material or labour costs, indication as to whether product is in stock, or further questions to be addressed to the customer. This information can be relayed back to the salesperson, who then proceeds to fill out the next section(s) of the digital sales form. It should be understood that the present invention is operable to route the queries that trigger the feedback to the appropriate application server(s), person or persons at the appropriate time. For example, it may be that within organization a particular risk assessment has to be approved by one of several managers. The API (108) is operable to interface back office calendar systems to know which of such managers is in the office or on approval duty at a particular time and route the request for feedback accordingly.
If there is no prohibitive feedback from the company, the salesperson will capture additional specific information regarding the product (insurance coverage or otherwise) that will enable the company to provide an accurate price quotation.
Checking the customer's product consumption, payment history or any other relevant criteria, including consideration of more recent information provided by the customer to the salesperson, the seller can apply the appropriate discount factor to establish the price for quotation. This information is then routed back to the communication device of the salesperson who will then write the price quoted into appropriate field of the form (e.g., monthly premium payable field on the sample form provided below).
Based on the information provided in the payment section, the company can charge the customer's credit/debit card or set up a direct debit transaction against the bank account, provided the required technology infrastructure to execute such transactions is available. If this is successful, the company can authorize the sales transaction (i.e. issue the policy number and the policy is in force, as per the vessel insurance sample below).
Optionally, the digital sales form can be used to obtain a signature from the salesperson (evidencing authorization of the sale) and/or the customer (evidencing acceptance of the terms). At the same time as obtaining the handwritten signature, the signature can also be captured biometrically using a number of known methodologies. For example, the biometric signature can be stored and used in subsequent transactions for purposes of non-repudiation. It should be understood that in connection with certain sales transactions there may be a requirement for obtaining signing documents, for example in the real estate, insurance or stock brokering areas. This requirement can be readily met by operation of the present invention with minimal departure from existing paper based processes.
Lastly, as an option, only the signature or the entire form will be sent allowing the previous section-by-section data transmissions to be validated against the last transmission. Such transmission validation is highly recommended to ensure integrity of data has not been compromised.

It will be appreciated by those skilled in the art that other variations of the preferred embodiment may also be practiced without departing from the scope of the present invention. Further illustration of the present invention is provided by way of the following examples.

### EXAMPLES

The present invention is further explained by reference to a series of specific examples in operation based on specific digital sales forms. It should be understood that various other forms and industry applications of the present invention are possible.

### Vessel Insurance Application

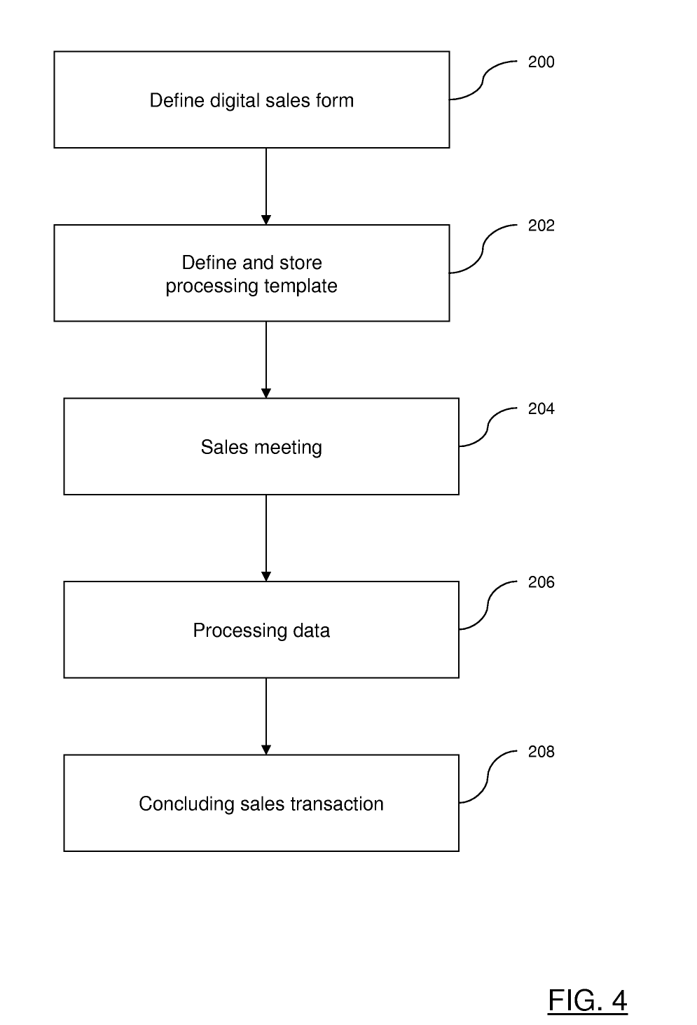

The sample form illustrated in FIG. 4 is provided on digital paper is to be filled out. Information written into the blue area of the Form using a digital pen will not only be immediately digitized, it will also be identified in relation to its specific location on the form. Therefore, for example, the system will know that it has to apply the social insurance validation algorithms to the information entered on line 7, starting at column 2 and ending on column 12.

Many countries utilize ‘intelligent numbering schemes’ for their social insurance, social security, passport, identity card numbers, making data validation possible. It is possible to include correction column(s) as part of each row that can be utilized to correct data flagged erroneous as a result of data validation by the back office system(s).

### Processing of the Insurance Form

In this example, the Digital Insurance Application Form is divided into five “logical” sections, each ending with a ‘Send box’. Once a section is completed, marking the ‘Send box’ triggers the transmission of data written onto the digital form (and digitized by the digital pen) to the connected communication device, like a GSM™ telephone. Information written onto the form is captured and transmitted to the predefined e-mail, Short Message Service (“SMS”) or Multimedia Messaging Service (“MMS”) or other type of server addresses for further processing.

The system facilitates various data transmission formats to be used, like MMS, which allows sending a single message to multiple recipients. This capability of MMS enables the creation of high security redundant information relay infrastructure. Beside MMS, there are other data transmission alternatives also, which would be recognized by a person skilled in the art.

### Personal Information Section

The purpose of the personal information section is for capturing information based upon which the identity of the prospect/customer can be determined. Once all personal information is completed in the section, the salesperson marks the SEND box and the information written on the form and captured by/stored into the digital pen will be transmitted to the communication device. As part of the data transmitted, the sender can also be identified based on the unique serial number of digital pen used.

As soon as the first data transmission is received, based on the pen ID and the form ID the company knows who the salesperson and what the intended product is. Using Global Positioning Service (“GPS”) enabled communications devices, like the MOTOROLA™ A780 cellular phone, even the exact location of the salesperson can be known, which can actually be extremely helpful if the sales effort at a certain point requires the involvement of a senior salesperson/expert.

The personal information that is received in the first data transmission will be analyzed according to validation rules provided by the company. The form should be constructed in a way that enables the company to accurately identify the customer.

Once it is known who the customer (or prospect) is, which product is being considered, and also who the salesperson is, the company generally has a lot of useful information at hand:
The identity of the customer (or prospect) enables the company to determine whether or not the product considered is available to that customer. Having access to and interaction with various processing systems and database(s) at that point enables the company to undertake different data validations, such as names and addresses, postal codes in sync with telephone area codes, birth date validations, etc. Based on existing policy number(s) provided in the personal information section, querying the policy management system, the customer's previous relationship to the company can be determined, analyzing his/her payment history, customer rating, etc., can be established. Also, in light of the existing service/product utilization of customer or other business considerations, like a particular ongoing product promotion, the company might disagree with the salesperson and propose a different product. Such ‘disagreement’ can be communicated back to the salesperson's communication device for further consideration by the customer.
If the education and training profile of the salespersons exists and can be accessed by the current system, a query to an HR database enables the company to determine whether the salesperson has the proper qualifications to conduct the particular sale to the particular customer. For example, in the case of a junior salesperson, lacking sufficient training and experience, trying to sell a complex product to a sophisticated customer, the company might decide to alert a more senior salesperson with a more appropriate skill set in proximity to join the sales effort. Proximity can be determined using GPS enabled telephones. The use of the present invention can create the foundation to a completely new dimension in sales force management methodology. Notification can be done by sending an SMS/MMS, e-mail or by even placing a direct phone call. This particular capability can facilitate a real-time view into the activity of a given sales force at any point in time at low cost, by using Pen-ID, Form-ID and the customer ID, opening up powerful management opportunities.
Knowing the customer's complete product/service consumption and payment history, the company also knows what price discount can be applied once all relevant parameters of the sale are clarified.

### Vessel Information Section

The vessel information section serves the purpose of determining the exact features and characteristics of the product in consideration. While the personal information is being processed by the back office system(s) of the company, the salesperson proceeds to filling out the next section of the form. Once this section is completed, the second SEND field is marked and the data captured in the vessel information section is transmitted to the central server via the connected telecommunication device for processing.

Receiving this information, the company knows exactly what the intended product is and can make the determination whether or not that product is available to the customer in question and at what price.

### Insurance Coverage Section

After the sum assured and the payment mode related answers are given along with whether or not there is a loan on the vessel, the third SEND field is marked.

Head Office Systems will at this point be in a position to calculate the premium based on the information provided during the previous data transmissions. The premium to be paid information is relayed back to the communication device of the salesperson who will write it into the monthly premium field of the digital application form.

Depending on chosen payment method and the infrastructural conditions, e.g., on-line connection to the customer's bank account of customer, the company might be able to collect the first premium or set up the direct debit payment mandate with the customer's bank.

Subsequent to the payment information being recorded and transmitted by engaging the fourth SEND field, the company can issue the policy number and relay it back to the communication device of the Salesperson, who can then write it into the Policy Number field on the form.

It is possible to provide a unique ID to each and every digital application form, that can be used as or part of the policy number. This powerful feature can serve as the bases to manage and provide audit trail for the two way communication between the insurance company and the salesperson's communication equipment (e.g., the digital pen and mobile phone).

As a last step, the customer/applicant signs the policy application form and the last SEND field is marked, at which point the customer's signature or the entire document can be resent.

The digital paper can have ordinary sheets (forms) interleaved with ‘carbon copy’ attached so that a copy of the application form can be left with the customer.

### Mortgage Application

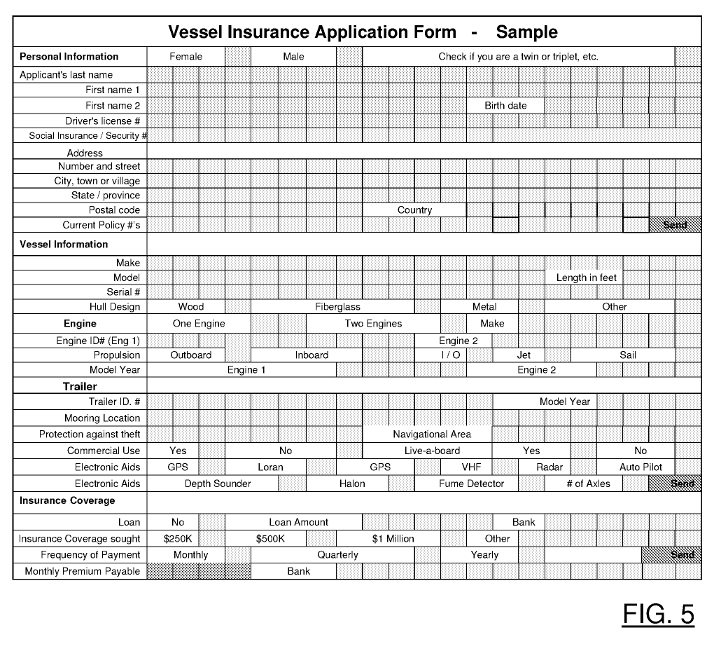

The form provided in FIG. 5 is an example for selling/processing mortgage products. Similar to the insurance example, multiple interactions can take place with back-end systems and the connected communications device.

### Personal Information Section

The purpose of the personal information section of the form is to capture information based on which the identity of a mortgage applicant can be established. In typical cases, banks/mortgage companies perform a credit check before making an offer to the applicant. Such operations might be based on internal systems/databases, but there are also credit bureaus that provide such service real time as well as off-line. Information to be able to execute a credit check according to the form above is captured in a primary borrower's personal information, co-borrower's personal information and the primary borrower's employment information sections.

Once the personal information and the mortgage sections are completed, the salesperson marks the SEND box and the information written on the form will be transmitted from the pen to the central server via the connected communication device.

The information captured has to conform to the processing requirements set out by the company. Once data validation is completed, for instance telephone area codes are cross-referenced against postal codes, and social security numbers are checked, etc., the mortgage approval processes will start. Although these processes differ depending on the particular mortgage institution, they typically include credit check and different steps of risk analysis. Some banks for instance do not provide mortgage loans in flood zones or do so at a higher than their normal rate. The Company has to provide the exact definitions of the approval steps in order to synchronize them with the current inventions.

### Mortgage Section

The mortgage section serves the purpose of determining the exact features and characteristics of the real estate loan in consideration. Based on the personal and the mortgage related information provided, the company will be in the position of determining whether or not requested loan can be provided, and, if so, at what rate.

After processing the information transmitted, the monthly mortgage payment, the term and the interest rate information is relayed back to the connected communication device. The information will be written in the appropriate fields on the form, the YES box is marked on the proceed field, indicating acceptance by the customer. This information is then sent to the central server that will return an approval number that the salesperson will again write to the appropriate field (approval number) on the form.

As the last step, the date field is filled out, the borrower(s) sign the form and the last SEND field is marked, at which point the applicant(s)'s signature or the entire document can be resent.

The digital paper can have ordinary sheets (forms) interleaved with ‘carbon copy’ attached so that a copy of the Application form can be left with the Customer.

### Tool Sales

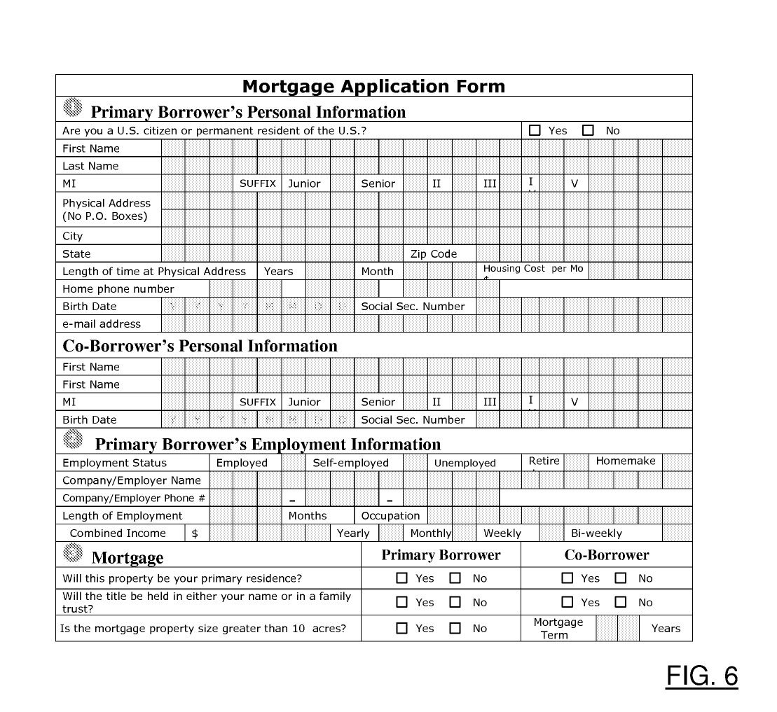

The sample form illustrated in FIG. 6 can be used for selling consumer items, such as power tools, where expert advice as part of the sales effort can be important.

Sales of products, where there are multiple choices regarding components, usage, applicability etc., can be much enhanced and increased if an expert advice/knowledge is available at the time of purchase. The lack of such expertise is one of the greatest shortcomings of the on-line or off-line catalogue based purchases. The so called traveling sales man with the form containing the appropriate multiple choice questions and having the right expertise is not only capable of providing proper answers to questions, but for instance by inspecting the site of the “problem” (customer's site), he/she can come up with advice he/she would not be possible. Seeing how customer performs a particular operation, the traveling sales expert can advise the customer that there are ways/tools that facilitate increased effectiveness.

Once the personal/company and the product related information is captured, the salesperson transfers the pen data to the central server via his/her communications device and receives the suggested model in response that best meets feature requirements defined during the sales consultation and also the price, that the salesperson writes into the appropriate data fields on the form.

If the customer wishes to proceed, the payment information is provided, then the second SEND box is activated and the payment information will be transferred to the central server via the connected communications device. If credit/payment information is processed and product availability is verified, order confirmation number and the date of shipment information can be returned to the salesperson's connected communications device.

As a last step, the customer signs the form and the last SEND box is marked. The digital paper can have ordinary sheets (forms) interleaved with ‘carbon copy’ attached so that a copy of the application form can be left with the customer.

### Credit Card/Personal Loan Application

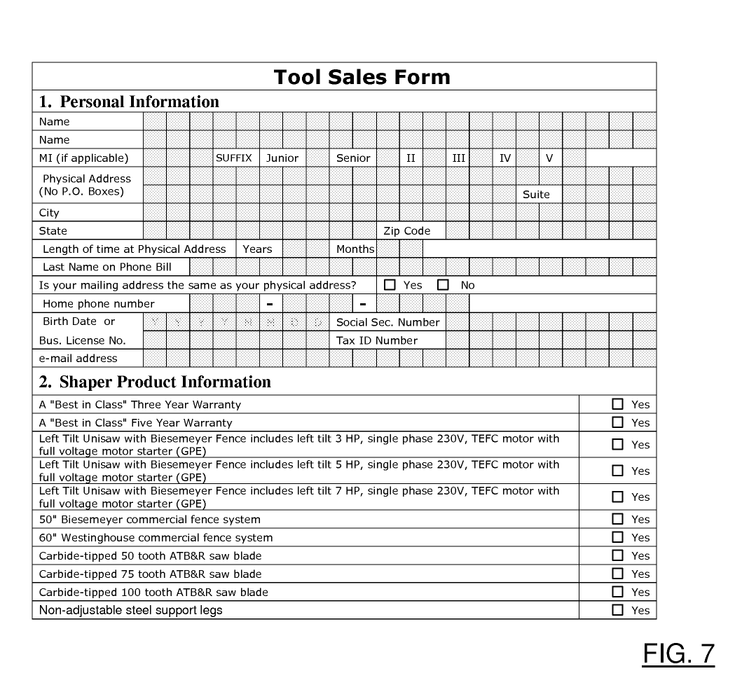

The sample form illustrated in FIG. 7 can be used for selling financial products such as credit cards and personal loans.

Sales of many products in the financial services industry require the customer's signature to be captured along with information essential for the company to make decisions regarding the service/product in consideration. In the credit card/personal loan application form shown in FIG. 7, personal and employment information is required for the company be able to perform the necessary steps of customer identification, credit check and risk assessment.

Once the personal/employment and the desired product related data is captured, data written on the credit card/personal loan application form is transferred from the pen to the central server via the connected communications device by marking the first SEND box.

Once the information sent, is processed by the company, the rate and the monthly payment and/or the credit card approval number will be relayed back to the connected communication device, depending on what product was chosen. The salesperson then writes the credit card approval number and/or the rate, monthly payment amount information into the appropriate data fields that are marked in colour on the forms.

If the customer wishes to proceed, then the “add an authorized card user” section is filled out, if applicable, and the customer signs the form and the second SEND box is marked. Information will be transferred to the central server via the connected communications device. Subsequent to processing the information by the head office, approval number is (can be) returned to the connected communications device.

If the customer finds this acceptable, s/he signs the form, and the last SEND box is marked and the signature of the customer or the entire form is re-sent.

The digital paper can have ordinary sheets (forms) interleaved with ‘carbon copy’ attached so that a copy of the application form can be left with the customer.

There are products/services that can be offered directly to the customer (or prospect), in which case the digital form and the digital pen also must be provided to the customer to complete the form.

What is claimed is:

1. A method for enabling sales support to a salesperson remotely located from an office, the method comprising:
(a) digitizing hand written data on a medium, such medium optionally including a digital pattern;
(b) receiving the data from the salesperson, wherein the data is sent using a communication device;
(c) processing the data; and
(d) generating feedback.

2. The method of claim 1 wherein the data is generated by the salesperson using a digital pen in conjunction with the medium.

3. The method of claim 2 wherein the medium is a sales form that embodies steps of a sales process, and the data is generated in consultation with a customer.

4. The method of claim 1 wherein the data is encrypted when sent by the salesperson and decrypted when received.

5. The method of claim 1 wherein the data is processed according to pre-determined criteria set established by the office.

6. The method of claim 1 wherein the data is processed via a comparison with a processing template.

7. The method of claim 1 wherein the feedback is in association with a transaction and includes information, approvals, or a request for further information.

8. The method of claim 1 wherein the data includes a customer signature.

9. The method of claim 1 wherein the feedback enables transactions with customers to conclude.

10. A method for enabling live sales support to a remote salesperson, the method comprising:
(a) defining a digital sales form for a sales process;
(b) defining a processing template based on the digital sales form;
(c) receiving data from the salesperson, wherein the data is generated by a digital pen in conjunction with the digital sales form by the salesperson in consultation with a customer, and wherein the data sent by a communication device;
(d) comparing the data with the processing template; and
(e) providing feedback to the salesperson.

11. The method of claim 10 wherein the data is encrypted when sent by the salesperson and decrypted when received.

12. The method of claim 10 wherein the feedback is encrypted when sent to the salesperson and decrypted when received by the salesperson.

13. The method of claim 10 wherein the feedback is in association with a transaction with the customer and includes information, approvals, or a request for further information.

14. The method of claim 10 wherein the data includes a customer signature.

15. The method of claim 10 wherein the digital sales form is tailored to the sales process.

16. The method of claim 10 wherein the feedback enables a transaction with the customer to conclude.

17. A system for enabling live sales support for a salesperson located remotely from an office, the system comprising:
(a) a digital pen operable to generate electronic data when used with a digital sales form in relation to a transaction; and
(b) a communication device linked to the digital pen, the communication device operable to transmit data over a network to office systems;
wherein the office systems transmit to the salesperson feedback regarding the transaction.

18. The system of claim 17 wherein the digital sales form comprises data fields for entry of customer information relevant to the transaction.

19. The system of claim 17 wherein the digital sales form includes one or more SEND fields in association with one or more sections of the data fields.

20. The system of claim 17 wherein the data comprises customer information relevant to the transaction.

21. The system of claim 17 wherein the communication device is a mobile phone.

22. The system of claim 21 wherein the communication device is a personal digital assistant device optionally linked to the mobile phone.

23. The system of claim 17 wherein the communication device is a portable computing device linked to a mobile phone.

24. The system of claim 23 wherein the portable computing device is a tablet or laptop.

25. The system of claim 17 wherein the data is encrypted when transmitted.

26. The system of claim 17 wherein the feedback includes information, approvals, or a request for further information.

27. The system of claim 17 wherein the feedback is generated by processing the data in association with a processing template, the processing template stored in a database.

28. The system of claim 17 wherein the digital pen is linked to a character recognition program.

29. The system of claim 17 wherein the data includes a customer signature.

30. The system of claim 17 wherein the digital sales form is paper-based and includes signatures for authentication and non-repudiation.

31. The system of claim 30 wherein the digital sales form is left with a customer after conclusion of the transaction.

32. The system of claim 17 wherein the feedback enables the transaction to conclude.

33. A system for providing live sales support to a salesperson located remotely from an office, the system comprising an application program interface operable to receive data from a communication device, wherein the data is received via a network, wherein the data is generated by a digital pen and sales form used by the salesperson in relation to a transaction, wherein the application program interface is linked to office systems by a server, wherein the office systems process the data and provide feedback, and wherein the feedback provided to the salesperson.

34. The system of claim 33 wherein the office systems comprise an application repository.

35. The system of claim 34 wherein the application repository comprises a plurality of applications directed at processing, recording and analysing transactional data.

36. The system of claim 35 wherein a listener/sender program integrates dataflow from the application program interface to the application repository.

37. The system of claim 33 wherein the feedback is generated by a messaging utility.

38. The system of claim 37 wherein the messaging utility is linked to the application program interface or the office systems.

39. The system of claim 33 wherein the data comprises customer information relevant to the transaction.

40. The system of claim 33 wherein the data is decrypted when received from the digital pen and/or the communication device.

41. The system of claim 33 wherein the application program interface includes a data extraction module.

42. The system of claim 41 wherein the data extraction module is an electronic data interchange.

43. The system of claim 33 wherein the feedback includes information, approvals, or a request for further information.

44. The system of claim 33 wherein the feedback is generated by processing the data in association with a processing template, the processing template stored in a database.

45. The system of claim 33 wherein the application program interface is linked to a database, the database including a rules repository.

46. The system of claim 45 wherein the application program interface is operable to authenticate, validate and analyse the data and/or distribute data to one or more back-end systems in accordance with one or more processing templates provided in the rules repository.

47. The system of claim 46 wherein the one or more processing templates are associated with the sales form.

48. The system of claim 33 wherein the data includes a customer signature.

49. The system of claim 33 wherein the sales form is digital paper-based and includes signatures for authentication and non-repudiation.

50. The system of claim 33 wherein the feedback enables the transaction to be concluded.

51. A computer program product for enabling live sales support for a salesperson located remotely from an office, the computer program product for use on a server computer, the computer program product comprising:
(a) a computer usable medium; and
(b) computer readable program code recorded or storable in the computer useable medium, the computer readable program code defining a server application on the server computer that is operable on the server computer to establish an application program interface;
wherein the application program interface includes a data extraction module operable to receive data from a communication device over a network, the data generated by a digital pen and sales form used by the salesperson in relation to a transaction;
wherein the application program interface is linked to a database, the database including a rules repository, wherein the application program interface is operable to authenticate, validate and analyse the data in accordance with one or more processing templates provided in the rules repository;
wherein the application program interface is linked to office systems, wherein a listener/send program integrates the flow of data from the application program interface to the office systems, the office systems process the data and provide feedback; and
wherein a messaging utility provides the feedback to the salesperson.
